(19) United States
(12) Patent Application Publication
(10) Pub. No.: US 2004/0204253 A1
(43) Pub. Date: Oct. 14, 2004

(54) Constant velocity joint fabric cover

(76) Inventor: Jeffrey Martin Wohlschlegel, Troy, MI (US)

Correspondence Address: GKN DRIVELINE NORTH AMERICA, INC, 3300 UNIVERSITY DRIVE, AUBURN HILLS, MI, 48326, US

(21) Appl. No.: 10/408,994

(22) Filed: Apr. 8, 2003

(51) Int. Cl. F16D 3/84

(52) U.S. Cl. 464/173

(57) ABSTRACT

A constant velocity joint sealing system comprising an internal grease shield located adjacent to the constant velocity joints, a boot cover affixed to the internal grease shield, and a flexible fabric cover affixed to the grease shield, boot cover and constant velocity joint.

### TECHNICAL FIELD

The present invention relates to an improved sealing system for a constant velocity joint that retains durability when subjected to automotive underbody environmental conditions.

### BACKGROUND ART

There are generally four (4) main types of automotive drive line systems. More specifically, there exists a full-time front wheel drive system, a full-time rear wheel drive system, a part-time four wheel drive system, and an all-wheel drive system. Most commonly, the systems are distinguished by the delivery of power to different combinations of drive wheels, i.e., front drive wheels, rear drive wheels or some combination thereof. In addition to delivering power to a particular combination of drive wheels, most drive systems permit the respectively driven wheels to rotate at different speeds. For example, the outside wheels must rotate faster than the inside drive wheels, and the front drive wheels must normally rotate faster than the rear wheels.

Drive line systems may include one or more Cardan (Universal) joint(s) and Constant Velocity joints (CVJ/s). Cardan joints are a common joint type used, for example, on propshafts. Although highly durable, Cardan joints are typically not suited for applications with high angles (e.g. >2 degrees) because of their inability to accommodate constant velocity rotary motion. Constant Velocity joints, in contrast, are well known in the art and are employed where transmission of a constant velocity rotary motion is desired or required. For example, a tripod joint is characterized by a bell-shaped outer race (housing) disposed around an inner spider joint which travels in channels formed in the outer race. One type of constant velocity universal joint is the plunging tripod type, characterized by the performance of end motion in the joint. Plunging tripod joints are widely used as the inboard (transmission side) joint in front wheel drive vehicles. A common feature of tripod universal joints is their plunging or end motion character.

The plunging tripod joint accommodates end wise movement within the joint itself with a minimum of frictional resistance, since the part-shpherical rollers are themselves supported on the arms by needle roller bearings. In a standard ball roller type constant velocity joint, the intermediate member of the joint (like the ball cage in a rzeppa constant velocity joint) is constrained to always lie in a plane which bisects the angle between the driving and driven shafts. Since the tripod type joint does not have such an intermediate member, the medium plane always lies perpendicular to the axis of the drive shaft.

Another common type of constant velocity universal joint is the plunging VL or “Cross groove” type, which consists of an outer and inner race drivably connected through balls located in circumferentially spaced straight or helical grooves alternately inclined relative to a rotational axis. The balls are positioned in a constant velocity plane by an intersecting groove relationship and maintained in this plane by a cage located between the two races. The joint permits axial movement since the cage is not positionably engaged to either race. As those skilled in the art will recognize, the principal advantage of this type of joint is its ability to transmit constant velocity and simultaneously accommodate axial motion. Plunging VL constant velocity universal joints are currently used for high speed applications such as, for example, the propeller shafts found in rear wheel drive, all-wheel drive, and 4-wheel drive vehicles.

The high speed fixed joint (HSFJ) is another type of constant velocity joint well known in the art and used where transmission of high speed is required. High speed fixed joints allow articulation to an angle (no plunge) but can accommodate much higher angles than with a Cardan joint or other non-CV joints such as, for example, rubber couplings. There are generally three types of high speed fixed joints: (1) disk style that bolts to flanges; (2) monoblock style that is affixed to the tube as a center joint in multi-piece propshafts; and (3) plug-on monoblock that interfaces directly to the axle or T-case replacing the flange and bolts.

A HSFJ generally comprises: (1) an outer joint member of generally hollow configuration, having a rotational axis and in its interior, a plurality of arcuate tracks circumferentially spaced about the axis extending in meridian planes relative to the axis, and forming lands between the tracks and integral with the outer joint part wherein the lands have radially inwardly directed surfaces; (2) an inner joint member disposed within the outer joint member and having a rotational axis, the inner joint member having on its exterior a plurality of tracks whose centerline lie in meridian planes with respect to the rotational axis of the inner joint member in which face the tracks of the outer joint member and opposed pairs, wherein lands are defined between the tracks on the inner joint member and have radially outwardly directed surfaces; (3) a plurality of balls disposed one in each pair of facing tracks in the outer and inner joint members for torque transmission between the members; and 94) a cage of annular configuration disposed between the joint members and having openings in which respective balls are received and contained so that their centers lie in a common plane, wherein the cage has external and internal surfaces each of which cooperate with the land surfaces of the outer joint member and inner joint member, respectively, to locate the cage and the inner joint member axially.

In joints of this kind, the configuration of the tracks in the inner and outer joint members, and/or the internal and external surfaces of the cage are such that, when the joint is articulated, the common plane containing the centers of the balls substantially bisects the angle between the rotational axis of the joint members. As indicated above, there are several types of high speed fixed joints differing from one another with respect to the arrangement and configuration of the tracks in the joint members and/or to the internal and external surfaces of the cage whereby the common bisector plane is guided as described above, thereby giving the joint constant-velocity-ratio operating characteristics. In each design, however, the cage is located axially in the joint by cooperation between the external cage surface and the surfaces of the lands facing the cages surface.

The outer surface of the cage and cooperating land surfaces of the outer joint member are generally spherical. When torque is transmitted by the joint, the forces acting in the joint cause the cage to be urged (by e.g. ball expulsion forces) toward one end of the joint which end will depend on the respective directions of the offsets of the tracks in the inner and outer joint members from the common plane when the joint is in its unarticulated position. To reduce the normal forces acting on the cage as a result of these ball expulsion forces, the amount of spherical wrap by the outer joint member lands is maximized for increased cage support.

In a disc-style constant velocity fixed joint, the outer joint member is open on both ends and the cage is assembled from the end opposite the end toward which the cage is urged by the ball expulsion forces under articulated load conditions. Assembly of the cage into the outer joint member is typically accomplished by either incorporating cage assembly notches into one of or a pair of lands in the outer joint member, or by sufficiently increasing the bore diameter of the outer joint part to allow the ball cage to be introduced into the outer joint part.

In a mono-block constant velocity fixed joint, also called a “mono-block high speed fixed joint”, the outer joint part is a bell-shaped member having a closed end. Accordingly, the cage must be assembled from the open end of the outer joint member. To accommodate assembly of the cage into the outer joint part, the bore diameter of the outer joint part must be sufficiently increased to allow assembly and/or assembly notches must be incorporated into at least one opposing pair of the outer joint member lands to allow introduction of the cage.

Driveline systems may also include one or more ball spline joints which include a plurality of balls enclosed within a cage to permit rotation around inner and outer respective races. Like constant velocity joints, ball spline joints are adapted to accommodate plunge in the axial direction, i.e., endwise movement. However, unlike constant velocity joints, ball spline joints do not permit articulation at an angle.

A typical driveline system incorporates one or more of the above joints in an all wheel drive or traditional four wheel drive system. In an all wheel drive system, such joints are used to connect a pair of propeller shafts (front and rear) (also called a propeller shaft assembly) to a power take off unit and a rear driveline module, respectively. These propeller shafts (“propshafts”) function to transfer torque to the rear axle in rear wheel and all wheel drive vehicles. Similarly, in a traditional four wheel drive system, such joints are used to connect the propeller shaft between a transfer case and the front axle.

Most constant velocity universal joints are sealed in order to retain grease inside the joint while keeping contaminants and foreign matter, such as dirt, water, and the like, out of the joint. In order to achieve this protection, the constant velocity joint is usually enclosed at the open end of the outer race by a sealing boot made of rubber, thermoplastic or urethane. The opposite end of the outer race is sometimes formed by an enclosed “dome”, known in the art as a grease cap. In addition to retaining grease and protecting the joint from contaminants, the sealing boot functions to remain durable throughout millions of propeller shaft articulation revolutions while operating continuously within predetermined temperature ranges (typically −40° to 120° C.) at speeds up to 6000 revolutions per minute. While the aforementioned rubber, thermoplastic and urethane boots have generally worked well on smaller joints, larger joints of the type now found on newer vehicles, have placed strain on conventional boots to respond to higher grease pressures and substantially greater temperatures. Consequently, a need exists for an improved constant velocity joint boot which is capable of responding favorably to the above pressure and temperature demands.

### DISCLOSURE OF THE INVENTION

It is a principal object of the present invention to provide a constant velocity joint boot operative to respond favorably to high internal grease pressures and temperatures.

In carrying out the above object, there is provided an improved constant velocity joint boot adapted for use in a constant velocity joint having a grease cover and an internal grease shield. The boot comprises a flexible fabric cover affixable to the grease shield and a stub shaft. In a preferred embodiment, the fabric cover is lightweight, tear-resistant, fretting-resistant, water-resistant, and highly flexible. In this embodiment, the grease cover is comprised of metal affixable to the constant velocity joint by a sealant. The grease cover further forms the outer element of a two piece grease shield.

The above object and other objects, features, and advantages of the present invention will become more readily apparent from the following detailed description of the best modes for carrying out the invention when taken in conjunction with the accompanying drawings.

### BRIEF DESCRIPTION OF DRAWINGS

FIG. 1 is a perspective view of a representative all wheel drive system which may be adapted to receive the sealing solution of the present invention;

FIG. 2 is a diagrammatical depiction of the drive system of FIG. 1;

FIG. 3 is a diagrammatical view of a traditional four wheel drive system adapted to receive the improved sealing solution of the present invention;

FIG. 4 is a perspective view of the improved boot of the present invention;

FIG. 5 is an exploded perspective view of the improved boot of FIG. 4;

FIG. 6 is a right side elevational view of the improved boot of FIG. 4.

### BEST MODE FOR CARRYING OUT THE INVENTION

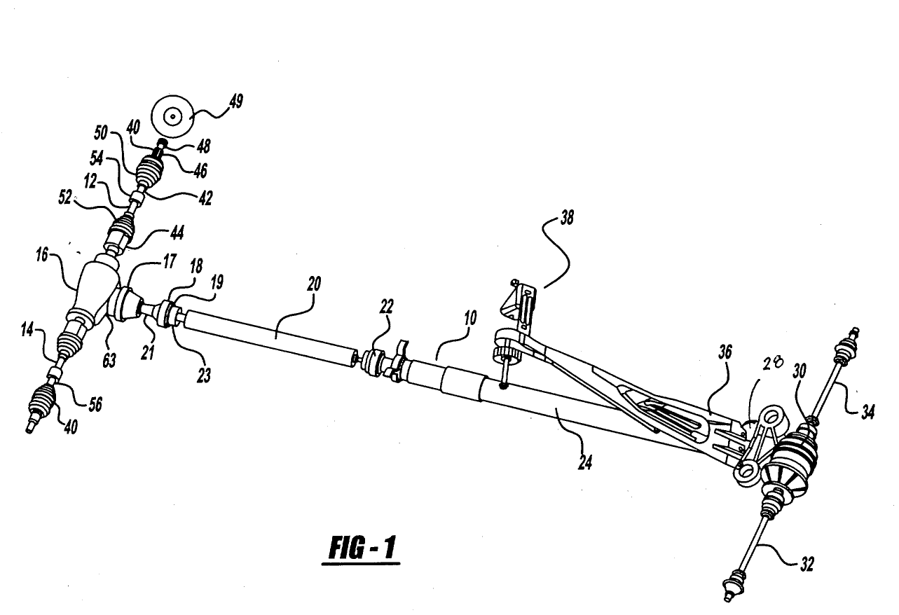

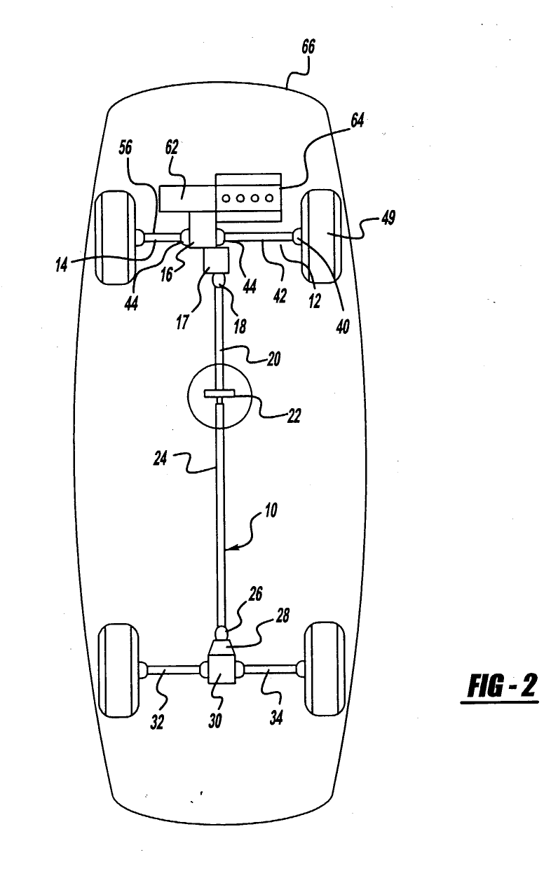

Referring to FIGS. 1-2 of the drawings, there is shown generally by reference numeral 10, a representative drive system of a motor vehicle. Drive system 10 comprises a pair of front half shaft assemblies designated as reference numerals 12 & 14, respectively. The front half shaft assemblies 12 & 14 are operatively connected to a front differential 16. Connected to front differential 16 is a power take-off unit 17. The power take-off 17 is operatively connected to a high speed fixed joint 18. Operatively connected to high speed fixed joint 18 is a front propeller shaft (“propshaft”) assembly 20. Operatively connected to front propshaft assembly 20 is a “VL” style plunging constant velocity joint designated as reference numeral 22. Connected to “VL” style plunging constant velocity joint 22 is rear propshaft assembly 24. Rear propshaft assembly 24 is connected on one end to cardan joint assembly 26. Cardan joint assembly 26 may be operatively connected to a speed sensing torque device 28. Speed sensing torque transfer device 28 is operatively connected to a rear differential assembly 30. A pair of rear half shaft assemblies 32 & 34 are each connected to rear differential assembly 30. As shown in FIG. 1, attached to the rear differential assembly 30 is torque arm 36. Torque arm 36 is further connected to torque arm mount 38.

Front half shaft assemblies 12 & 14 are comprised of fixed constant velocity joints 40, an interconnecting shaft 42 and a plunge style constant velocity joint 44. Plunge style constant velocity joints 44 are operatively connected to the front differential 16. Plunge style constant velocity joints 44 are plug-in style in this embodiment. However, any style of constant velocity joint half shaft assembly may be used depending upon the application. As shown in FIG. 1, the stem portion 46 is splined such that it interacts with a front wheel of a motor vehicle and has a threaded portion 48 which allows connection of the wheel 49 to the half shaft assembly 12.

There is also shown in FIG. 1, constant velocity joint boots 50 & 52, which are known in the art and are utilized to contain constant velocity joint grease which is utilized to lubricate the constant velocity joints. There is also shown an externally mounted dynamic damper 54 which is known in the art. U.S. Pat. No. 5,660,256, to the Assignee of the present invention, is herein incorporated by reference.

Halfshaft assembly 14 may be designed generally similar to that of halfshaft assembly 12 with changes being made to the length of interconnection shaft 56. Different sizes and types of constant velocity joint may also be utilized on the left or right side of the drive system, depending on the particular application.

The power take-off unit 17 is mounted to the face of the transmission 62 and receives torque from the front differential 16. The transmission 62 is operatively connected to the engine 64 of the motor vehicle 66. The power take-off unit 17 has the same gear ratio as the rear differential 30 and drives the front propshaft 20 through the high speed fixed joint 18 at 90 degrees from the front differential axis.

Still referring to FIGS. 1-2, in a typical four-wheel drive vehicle, the drive from transfer case 12 is transmitted to the front and rear final drive or differential units 16 and 30, respectively, through two propeller shafts 20 and 24. In the drive system shown, an internal combustion engine 64 is operatively connected to a front wheel drive transmission system 62. Front halfshaft assemblies 12 and 14 are operatively connected to transmission system 62. More specifically, transmission system 62 includes a front differential 16 as is known in the art which includes some means for receiving the plunging constant velocity joints 44 of the front halfshaft assemblies. Internal to the transmission 62, the front differential housing 63 is operatively connected to the power take-off unit 17. The power take-off unit 17 is further connected to a high speed fixed joint 18.

A high speed fixed joint 18 is connected at one end to the power take-off unit 17 and at the other end to a front propshaft 20. “VL” type plunging constant velocity joint 22 is similarly connected at one end to the rear propshaft 24 and at the other end to front propshaft 20. The high speed fixed joint may have a revolution-per-minute (RPM) capacity of 6000 RPMs with a preferable range of 300-5000 RPMs, a torque capacity of 5-1500 Nm with a preferable capacity of 600-700 Nm, and an angle capacity of up to 15 degrees with a preferable capacity of 3-6 degrees. Of course, the drive system may use other constant velocity joints and/or cardan joints or universal joint technology at this connection. However, a high speed fixed joint is generally preferred.

High speed fixed joint 18 includes a boot 23 which is utilized to enclose grease (not shown) required for lubrication of the high speed fixed joint 18. The front propshaft 20 in the present invention is manufactured from steel providing a very low run-out and critical speed capacity higher than the second engine order. Front propshaft 20 is operatively connected to constant velocity joint 22 by fasteners 25. Front propshaft 20 has a flange 27 extending out which is connected to constant velocity joint 22 by fasteners 25. High speed fixed joint 18 similarly includes a flange 19 extending out which is connected to front propshaft 20 by fasteners.

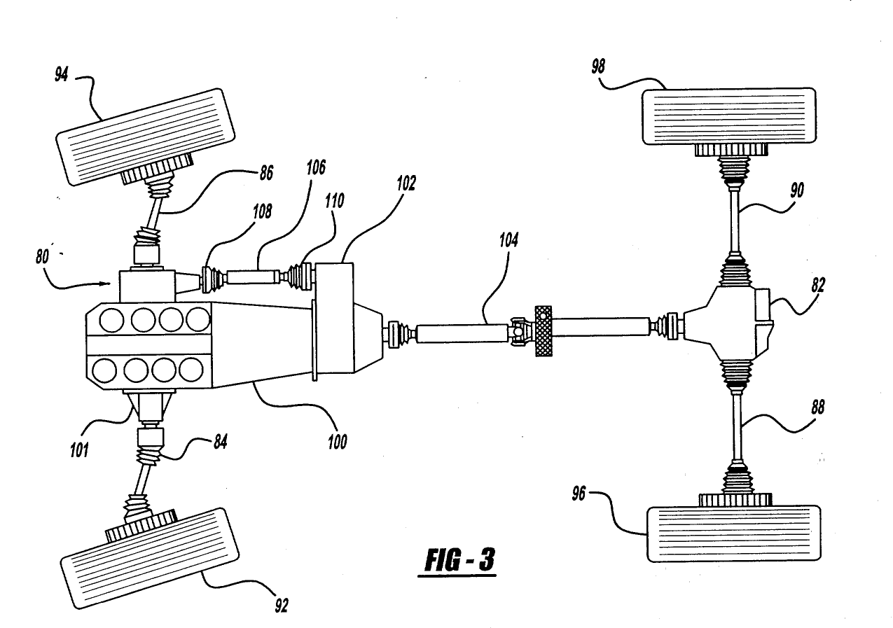

A representative diagram of a traditional four (4) wheel drive system is provided in FIG. 3. As shown, the front and rear axles 80 and 82 each comprise respective half shaft assemblies 84, 86, 88 and 90, which are affixable to driven wheels 92, 94, 96 and 98. Front half shaft assemblies 84 and 86 are further affixable to a combustion engine/transmission assembly 100 via bearing support assembly 101. Engine/transmission assembly 100 is further affixable to a transfer case 102, which, in turn, is affixable to a rear propeller shaft 104. Finally, a front propshaft 106 is affixable between transfer case 102 and front axle 80. As in the case of a front propeller shaft assembly in an all wheel drive system, the front propshaft 106 used in a traditional four wheel drive system also includes a high speed fixed joint 108 and a VL plunging joint 110 affixable at respective ends of the propshaft.

As indicated above, a sealing boot made of chloroprene rubber, thermal plastic or urethane has been typically used to provide support against contacting grease pressure keeping grease inside the constant velocity joint as well as to protect the joint from external contaminants such as rain, mud, gravel, stones, etc. on the stub shaft side. While conventional boot designs have been sufficient for smaller constant velocity joints and lower temperature ranges (e.g. −40° C. to 120° C.), larger size constant velocity joints require increased demand on durability at continuous high angles (11°). In response, joint diameters increased with attendant increase of the internal grease pressure and temperature operations. This may result in boot ballooning at high speeds and additional temperature demands that exceeded the limits of conventional rubber boot materials.

The present invention overcomes the difficulties of the prior art by providing a flexible fabric cover to occupy the same physical space as a conventional high speed fixed constant velocity joint boot. The fabric cover provides a light weight flexible element of articulation between the constant velocity joint outer body and stubshaft while protecting the joint from external contaminants that may enter the joint on the shaft side.

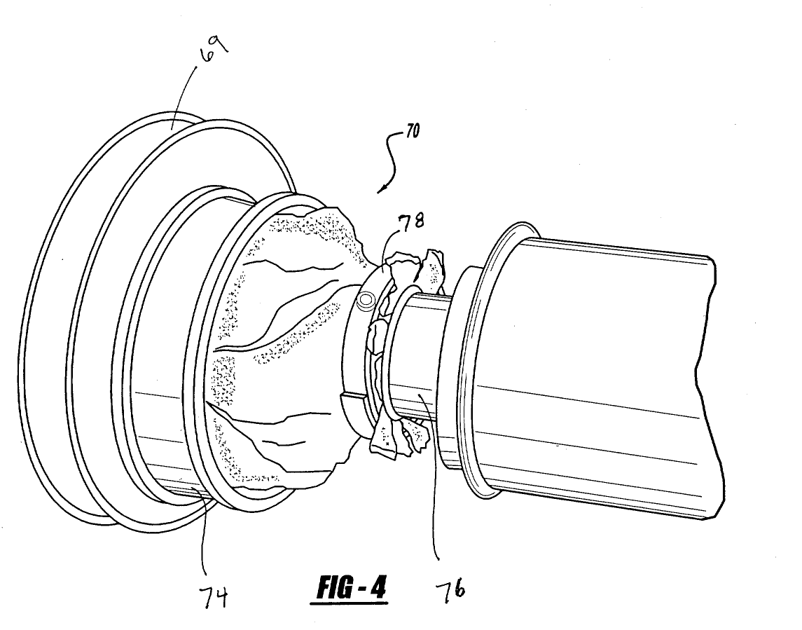

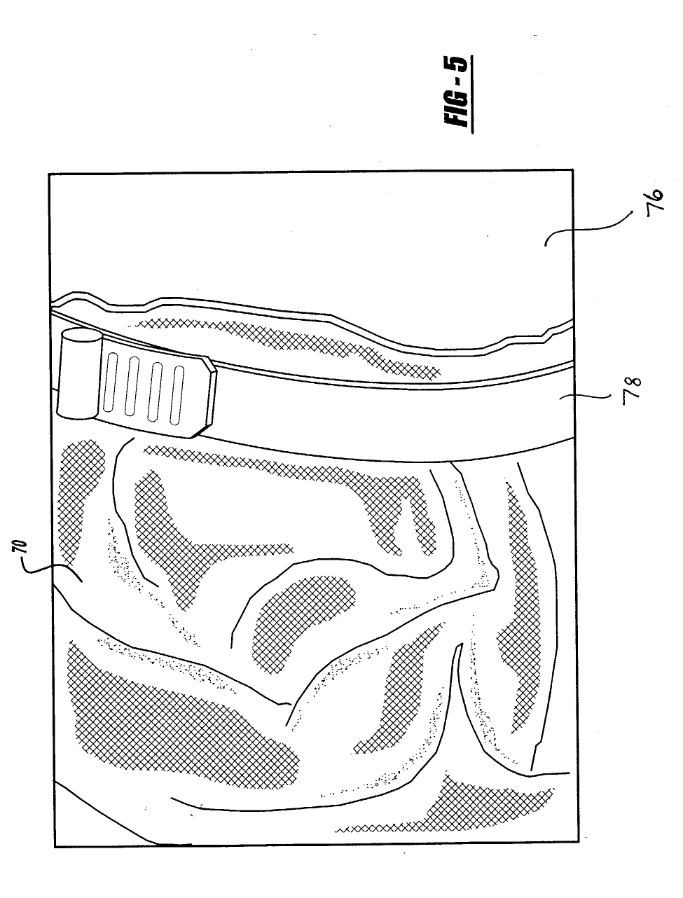

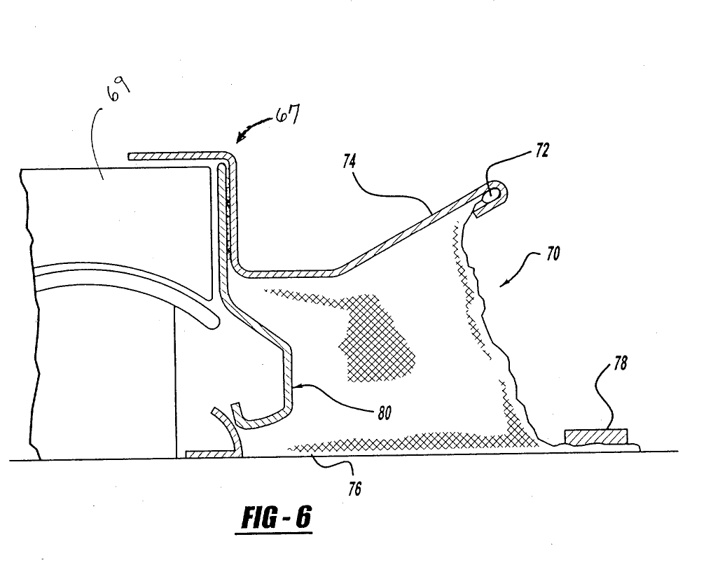

There is shown a constant velocity joint sealing system 67 in FIG. 6. The system 67 comprises an internal grease shield located adjacent to said constant velocity joints, a boot cover affixed to said internal grease shield, and a flexible fabric cover affixed to said grease shield, boot cover and constant velocity joint. The flexible fabric cover of the present invention is shown in greater detail in FIGS. 4-6 and designated generally by reference numeral 70. Alongside constant velocity joint 69 is fabric cover 70 which may be made out of any suitable material that is lightweight and preferably, but not necessarily, tear resistant, fretting resistant, water resistant and highly flexible. As indicated above, fabric cover 70 is intended to occupy the same physical space as a conventional high speed fixed CV joint boot. Fabric cover 70 is not, however, intended to provide a means of retaining grease within the constant velocity joint. As shown in FIG. 6, fabric cover 70 is intended to be used in conjunction with an existing boot cover 74 and internal grease shield 80. As shown, fabric cover 70 may be bonded using a mechanical locking/crimping mechanism 72 to boot cover 74, which may also serve as the outer element of multi-piece grease shield 80. The fabric cover 70 may also be bonded to boot cover 74 using an adhesive (not shown). The fabric cover 70 may be manufactured from a cotton, nylon, or other technically engineered fabric such as Gore-Tex® or Dupont Cordura. The fabric cover 70 may also be held in position to the stubshaft side 76 of the constant velocity joint 69 with a suitable retaining means such as, for example, padded clamp 78. In keeping with the invention, the padding is used as both a compressible material and also as a protective barrier from contact of any sharp metal edges with the fabric cover. In operation, fabric cover 70 functions to billow outward to a fully stretched position at high speeds, thus repelling external contaminants such as rain, dirt, gravel, stones, etc. before they reach the surface of the constant velocity joint.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A constant velocity joint sealing system for a constant velocity joint comprising:
an internal grease shield contacting the constant velocity joint on one side thereof;
a boot cover affixed to said internal grease shield and contacting the constant velocity joint; and
a flexible fabric cover affixed to said grease shield, boot cover and constant velocity joint.

2. A constant velocity joint sealing system as in claim 1, wherein the flexible fabric cover is tear resistant.

3. A constant velocity joint sealing system as in claim 1, wherein the flexible fabric cover is fretting resistant.

4. A constant velocity joint sealing system as in claim 1, wherein the flexible fabric cover is water resistant.

5. A constant velocity joint sealing system as in claim 1, wherein the flexible fabric cover is affixable to the boot cover by an adhesive.

6. A constant velocity joint sealing system as in claim 1, wherein the flexible fabric cover is affixable to the boot cover by a crimping mechanism.

7. A constant velocity joint sealing system as in claim 1, wherein the boot cover is affixed to the internal grease shield by a sealant.

8. A constant velocity joint sealing system as in claim 1, wherein the flexible fabric cover is affixable to the constant velocity joint by a padded clamp.

9. A constant velocity joint sealing system as in claim 1, wherein the boot cover is comprised of metal.

10. A constant velocity joint sealing system as in claim 1, wherein the boot cover forms the outer element of a two piece grease shield.

11. A constant velocity joint having a sealing system, said constant velocity joint including:
an outer race;
an inner race arranged within said outer race;
a boot cover contacting said outer race;
an internal grease shield arranged between said outer race and an inside surface of said boot cover; and
a flexible fabric cover arranged between said boot cover and a shaft.

12. The constant velocity joint of claim 11, wherein said flexible fabric cover is affixable to said shaft by a padded clamp.

13. The constant velocity joint of claim 11, wherein said flexible fabric cover billows in an outward direction at high speeds.
